(19) United States
(12) Patent Application Publication
(10) Pub. No.: US 2010/0265157 A1
(43) Pub. Date: Oct. 21, 2010

(54) Multi-band antenna

(76) Inventors: Wen-Chieh Yang, Tu-Cheng City (TW); Kai Shih, Tu-Cheng City (TW); Yu-Yuan Wu, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,773

(22) Filed: Apr. 20, 2009

(51) Int. Cl. H01Q 1/36

(52) U.S. Cl. 343/908

(57) ABSTRACT

A multi-band antenna includes a base plate having two opposite transverse edges and two opposite longitudinal edges respectively connected to the two transverse edges. A high frequency radiating element and a capacitance element are respectively bent downward from the two transverse edges of the base plate and then extend in a transverse direction. A feeding point is defined at one end of the capacitance element adjacent to the base plate. A low frequency radiating element extends from one longitudinal edge of the base plate. An inductance element extends from the other longitudinal edge of the base plate and has a transverse border exceeding the base plate in a longitudinal direction. A grounding element is bent downward from the transverse border of the inductance element and then extends in the same direction as the high frequency radiating element to be spaced from the capacitance element.

### BACKGROUND OF THE INVENTION

1. Field of the Invention

The present invention relates to an antenna, and more particularly to a multi-band antenna.

2. The Related Art

Antennas are used in various communication systems, such as cellular phones, notebook computers, wireless data and local area network, etc. The types of the antennas are also varied, including planar inverted-F antennas, monopole antennas, loop antennas and the like. Moreover, among present wireless technologies, wireless communication bands include global system for mobile communications (GSM) band about 850 MHz, extended global system for mobile communications (EGSM) band about 900 MHz, digital cellular system (DCS) band about 1800 MHz, personal communication services (PCS) band about 1900 MHz and wideband code division multiple access (WCDMA) band about 2000 MHz.

Generally, an antenna includes a radiating element, a grounding element, a capacitance element and an inductance element. The capacitance element and the inductance element are used to adjust a resonance frequency and an impedance matching of the antenna. A conventional antenna arranges the capacitance element adjacent to the grounding element. When the conventional antenna is assembled in a communication equipment, the capacitance element would likely be warped to contact the grounding element if the capacitance element is subject to an external force, which will cause a short-circuit between the capacitance element and the grounding element. As a result, the performance of the conventional antenna will be degraded.

### SUMMARY OF THE INVENTION

It is an object of the present invention to provide a multi-band antenna including a base plate which has two opposite transverse edges and two opposite longitudinal edges respectively connected to the two transverse edges. A high frequency radiating element is bent downward from one transverse edge of the base plate and then extends in a transverse direction. A low frequency radiating element extends from one longitudinal edge of the base plate. A capacitance element is bent downward from the other transverse edge of the base plate and then extends in the same direction as the high frequency radiating element. A feeding point is defined at one end of the capacitance element adjacent to the base plate. An inductance element extends from the other longitudinal edge of the base plate and has a transverse border exceeding the base plate in a longitudinal direction. A grounding element is bent downward from the transverse border of the inductance element and then extends in the same direction as the high frequency radiating element to be spaced from the capacitance element.

As described above, the arrangement of the high frequency radiating element and the low frequency radiating element secures the multi-band antenna to transmit and receive multiple band signals. The capacitance element is spaced from the grounding element, which not only ensures the capacitance effect between the capacitance element and the grounding element, but also avoids a short-circuit therebetween even though the multi-band antenna is warped on account of an external force.

### BRIEF DESCRIPTION OF THE DRAWINGS

The present invention will be apparent to those skilled in the art by reading the following description of an embodiment thereof, with reference to the attached drawings, in which:

FIG. 1 is a perspective view of a multi-band antenna in accordance with the present invention; and

FIG. 2 is a test chart recording of Voltage Standing Wave Ratio (VSWR) of the multi-band antenna as a function of frequency.

### DETAILED DESCRIPTION OF THE PREFERRED EMBODIMENT

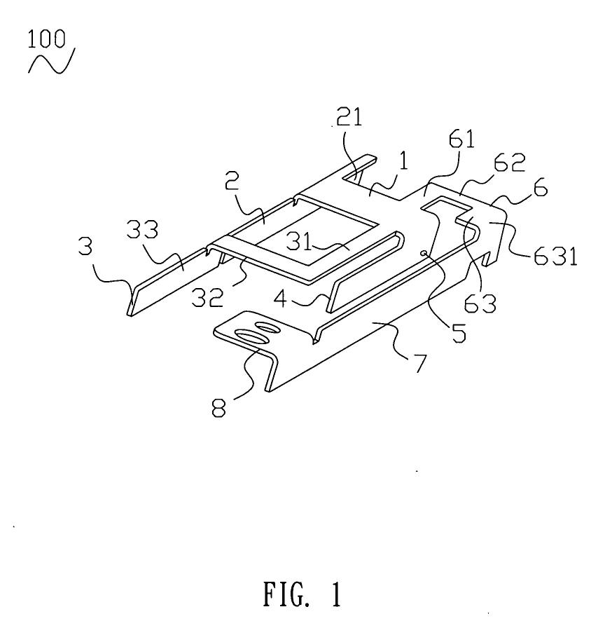

A multi-band antenna 100 according to a preferred embodiment of the present invention is illustrated in FIG. 1. The multi-band antenna 100 which may be formed by pattern etching a copper-plated sheet of synthetic material includes a substantially rectangular base plate 1 having two opposite transverse edges and two opposite longitudinal edges respectively connected to the two transverse edges.

A high frequency radiating element 2 bends downward from one transverse edge of the base plate 1 and then extends in a transverse direction. The high frequency radiating element 2 further has an extension portion 21 extended opposite to the high frequency radiating element 2. A capacitance element 4 bends downward from the other transverse edge of the base plate 1 and then extends in the same direction as the high frequency radiating element 2. The high frequency radiating element 2 and the capacitance element 4 face to each other. The capacitance element 4 defines a feeding point 5 at an end thereof adjacent to the base plate 1.

A low frequency radiating element 3 extends from one longitudinal edge of the base plate 1 and includes a first radiating strip 31, a second radiating strip 33 and an intermediate strip 32 connected with the first radiating strip 31 and the second radiating strip 33. The first radiating strip 31 perpendicularly extends from the base plate 1 and is arranged adjacent to the capacitance element 4. The intermediate strip 32 is extended perpendicularly from a free end of the first radiating strip 31 with a distal end thereof adjacent to a distal end of the high frequency radiating element 2. The first radiating strip 31 and the intermediate strip 32 are coplanar with the base plate 1. The distal end of the intermediate strip 32 is bent downward and then extended opposite to the high frequency radiating element 2 to form the second radiating strip 33 substantially in alignment with the high frequency radiating element 2.

The multi-band antenna 100 further includes an inductance element 6 extended from the other longitudinal edge of the base plate 1. The inductance element 6 is coplanar with the base plate 1 and has a first horizontal section 61 extended opposite to the first radiating strip 31 from the base plate 1, a second horizontal section 63 spaced from and parallel to the first horizontal section 61 and a connection section 62 perpendicularly connected both ends of the first horizontal section 61 and the second horizontal section 63 away from the base plate 1. The second horizontal section 63 has a transverse border 631 exceeding the base plate 1 in a longitudinal direction. A grounding element 7 bends downward from the transverse border 631 of the second horizontal section 63 and then extends in the same direction as the high frequency radiating element 2 to be spaced from the capacitance element 4. A top edge of a free end of the grounding element 7 extends perpendicularly towards the second radiating strip 33 to form a fixing portion 8.

When the multi-band antenna 100 is assembled in a mobile communication equipment, the grounding element 7 is connected to the ground. Then the inductance element 6 is connected with the ground through the grounding element 7. Because the inductance element 6 is a narrow strip metal, the inductance element 6 has a property of linearity. Therefore, the connection between the inductance element 6 and the grounding element 7 can substitute for an inductor to attain the same function. The capacitance element 4 is a long narrow strip spaced from the grounding element 7, so the capacitance element 4 and the grounding element 7 produce a capacitance effect and can substitute a capacitor to attain the same function. Thereby, the capacitance element 4 and the inductance element 6 enable the multi-band antenna 100 and a high-frequency circuit (not shown) to match with each other.

When the multi-band antenna 100 is used in wireless communication, an electric current is fed into the multi-band antenna 100 via the feeding point 5. The high frequency radiating element 2 produces a main resonance mode to secure the high frequency radiating element 2 for transmitting/receiving a higher frequency range covering 1800 MHz to 2000 MHz; while the low frequency radiating element 3 produces a main resonance mode to secure the low frequency radiating element 3 for transmitting/receiving a lower frequency range covering 850 MHz to 900 MHz. Therefore, the multi-band antenna 100 obtains frequency range corresponding to GSM band, EGMS band, DCS band, PCS band and WCDMA band in wireless communication.

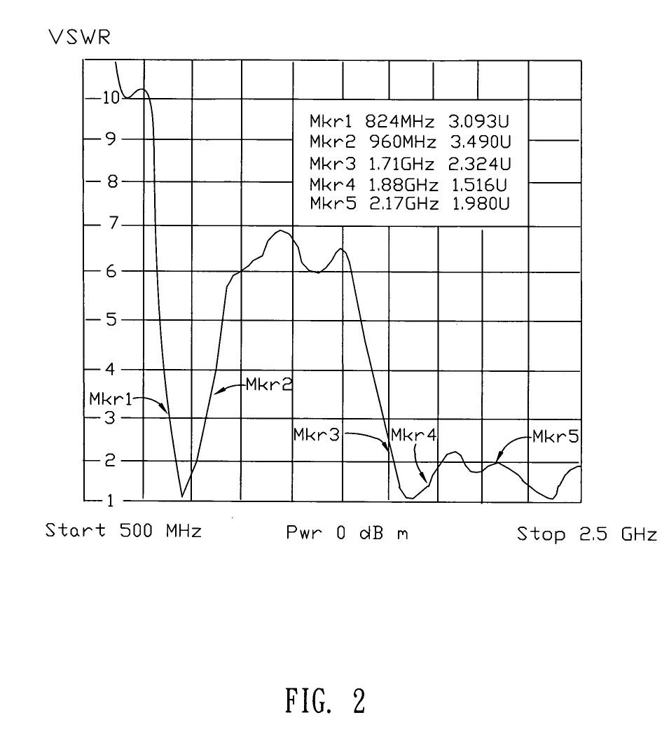

In order to illustrate the effectiveness of the present invention, FIG. 2 sets a test chart recording of Voltage Standing Wave Ratio (VSWR) of the multi-band antenna 100 as a function of frequency. The multi-band antenna 100 respectively works in 824 MHz (Mkr 1), 960 MHz (Mkr 2), 1.71 GHz (Mkr 3), 1.88 GHz (Mkr 4), and 2.17 GHz (Mkr 5), and the values of the VSWR are 3.093, 3.490, 2.324, 1.516 and 1.980, respectively.

As described above, the arrangement of the high frequency radiating element 2 and the low frequency radiating element 3 secures the multi-band antenna 100 to transmit and receive multiple band signals covering 850 MHz, 900 MHz, 1800 MHz, 1900 MHz and 2000 MHz. The capacitance element 4 is spaced from the grounding element 7, which not only ensures the capacitance effect between the capacitance element 4 and the grounding element 7, but also avoids a short-circuit therebetween even though the multi-band antenna 100 is warped on account of an external force.

What is claimed is:

1. A multi-band antenna, comprising:
a base plate having two opposite transverse edges and two opposite longitudinal edges respectively connected to the two transverse edges;
a high frequency radiating element bent downward from one transverse edge of the base plate and then extending in a transverse direction;
a low frequency radiating element extending from one longitudinal edge of the base plate;
a capacitance element bent downward from the other transverse edge of the base plate and then extending in the same direction as the high frequency radiating element, a feeding point being defined at one end of the capacitance element adjacent to the base plate;
an inductance element extending from the other longitudinal edge of the base plate, the inductance element having a transverse border exceeding the base plate in a longitudinal direction; and
a grounding element bent downward from the transverse border of the inductance element and then extending in the same direction as the high frequency radiating element to be spaced from the capacitance element.

2. The multi-band antenna as claimed in claim 1, wherein the high frequency radiating element has an extension portion extended opposite to the high frequency radiating element.

3. The multi-band antenna as claimed in claim 1, wherein the low frequency radiating element includes a first radiating strip perpendicularly extending from the base plate and arranged adjacent to the capacitance element and an intermediate strip coplanar with the base plate extending perpendicularly from a free end of the first radiating strip with a distal end thereof adjacent to a distal end of the high frequency radiating element, the distal end of the intermediate strip is bent downward and then extended opposite to the high frequency radiating element to form a second radiating strip substantially in alignment with the high frequency radiating element.

4. The multi-band antenna as claimed in claim 1, wherein the inductance element is coplanar with the base plate and has a first horizontal section extended from the base plate, a second horizontal section spaced from and parallel to the first horizontal section and a connection section perpendicularly connected both ends of the first horizontal section and the second horizontal section away from the base plate.

5. The multi-band antenna as claimed in claim 4, wherein the second horizontal section defines one edge thereof as the transverse border.
